(19) United States
(12) Patent Application Publication
(10) Pub. No.: US 2011/0238962 A1
(43) Pub. Date: Sep. 29, 2011

(54) Register Checkpointing for Speculative Modes of Execution in Out-of-Order Processors

(75) Inventors: Harold W. Cain, III, Hartsdale, NY (US); Kattamuri Ekanadham, Mohegan Lake, NY (US); IL Park, White Plains, NY (US)

(73) Assignee: INTERNATIONAL BUSINESS MACHINES CORPORATION, Armonk, NY (US)

(21) Appl. No.: 12/729,282

(22) Filed: Mar. 23, 2010

(51) Int. Cl. G06F 9/30

(52) U.S. Cl. 712/228; 712/E09.016

(57) ABSTRACT

A mechanism is provided for generating a checkpoint for a speculatively executed portion of code. The mechanisms identify, during a speculative execution of a portion of code, a register renaming operation occurring to an entry in a register renaming table of the processor. In response to the register renaming operation occurring to the register renaming table, a determination is made as to whether an update to an entry in a hardware-implemented recovery renaming table is to be performed. If so, the entry in the hardware-implemented recovery renaming table is updated. The entry in the recovery renaming table is part of the checkpoint for the speculative execution of the portion of code.

### BACKGROUND

The present application relates generally to an improved data processing apparatus and method and more specifically to mechanisms for performing checkpointing of registers during speculative modes of execution in out-of-order processors.

Many modern processors utilize architectures that support speculative execution of instructions. Speculative execution involves executing portions of code that may not in fact be needed by the program and determining after the speculative execution whether the results of the speculative execution are in fact needed or not. If the results of the speculative execution are needed, then the results are “committed”, i.e. the results are made non-speculative and may be made available to other processes through memory structures. If the results of the speculative execution are not needed, then the results are not committed and instead are discarded.

Many different types of speculative execution architectures are utilized in modern processors. For example, transactional memory, speculative lock elision, run-ahead processing, and others are some examples of speculative execution mechanisms. These mechanisms may need an efficient way of checkpointing register files so that a roll-back mechanism can restore a correct, non-speculative register state in the case that the results of the speculative execution are not needed, i.e. there is an incorrect speculation. Taking a snap-shot of the architectural register file or renaming table is a straight-forward and intuitive design option. However, the cost of doing so is very high in terms of performance since a relatively large number of processor cycles are required to actually perform the copying of architectural register file and/or renaming table state.

A typical place where register checkpointing mechanisms are necessary is in the speculative execution of instructions following a branch prediction. In such a case, all registers that are assigned to instructions and updated speculatively do not affect the architectural states of the register file. That is, the speculative results data is stored in separate registers from the architectural register file registers. When an instruction is about to retire, and the architectural state of the target register is about to change, it is guaranteed that all previous branches are already resolved. Only those speculative branches that are actually taken by the execution of the program are committed such that the architectural register file is updated by the speculative results stored in the corresponding separate speculative registers. The reasoning behind this is that the speculative interval due to the branch prediction is not very long, hence all speculatively executed register values can be temporarily stored in these separate physical registers, which are significantly smaller in number from the registers of the architectural register file.

The new speculative execution paradigms, such as transactional memory, speculative lock elision, run-ahead execution, and thread-level speculation, unlike branch prediction, may make use of speculation intervals that are too long to hold all temporary speculative values in a separate restricted set of physical registers. Unfortunately, it is very difficult to increase the number of physical registers in the modern high performance processors due to the nature of the register file design. For example, one challenge when increasing the number of physical registers is the access time. If the area increases, the access time increases. The register file is one of the most time critical components in the pipeline and thus, it is not desirable to increase the register file access time. The second challenge is the power consumption. The register file is one of the most power consuming logic circuits in the processor architecture. Increasing the number of registers means consuming more power which is not an acceptable result in most processor architectures.

### SUMMARY

In one illustrative embodiment, a method, in a data processing system, is provided for generating a checkpoint for a speculatively executed portion of code. The method comprises identifying, by a processor of the data processing system, during a speculative execution of a portion of code, a register renaming operation occurring to an entry in a register renaming table of the processor. The method further comprises, in response to the register renaming operation occurring to the register renaming table, determining, by the processor, if an update to an entry in a hardware-implemented recovery renaming table of the processor is to be performed. Moreover, the method comprises updating, by the processor, the entry in the hardware-implemented recovery renaming table in response to a determination that the entry in the recovery renaming table is to be updated. The entry in the recovery renaming table is part of the checkpoint for the speculative execution of the portion of code.

In yet another illustrative embodiment, a system/apparatus is provided. The system/apparatus may comprise a register renaming table unit, a recovery renaming table unit, and a logic unit coupled to both the register renaming table unit and the register recovery table unit. The logic unit operates to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a block diagram of an example data processing system in which aspects of the illustrative embodiments may be implemented;

FIG. 2 is an exemplary block diagram of a conventional dual threaded processor design showing functional units and registers in accordance with one illustrative embodiment;

FIG. 3 is an example diagram illustrating an operation for using a register renaming table and recovery renaming table in accordance with one illustrative embodiment;

FIG. 4 is a flowchart outlining an example operation for updating a recovery rename table in accordance with one illustrative embodiment; and

FIG. 5 is a flowchart of an example operation for handling an end of a speculative mode of execution using a recovery renaming table in accordance with one illustrative embodiment.

### DETAILED DESCRIPTION

The illustrative embodiments provide mechanisms for performing checkpointing of registers during speculative modes of execution in out-of-order processors. The checkpointing mechanisms of the illustrative may be used with various speculative execution paradigms including branch prediction, speculative lock elision, transactional memory, run-ahead execution, thread-level speculation, and the like. The mechanisms of the illustrative embodiments provide an efficient way of checkpointing a register file that incurs minimum costs of entering and exiting speculation mode and avoids any major pipeline change to support such checkpointing.

The checkpointing mechanisms of the illustrative embodiments do not utilize snap-shot mechanisms as would otherwise be the most intuitive way of making a register file checkpoint. Taking a snapshot of the entire register file is very expensive and time consuming and thus, would incur considerable cost with regard to the performance of the system, detracting from any performance benefit obtained from having speculative execution. Instead, the mechanisms of the illustrative embodiments use modified register renaming logic to create a checkpoint for registers. By using the modified register renaming logic, the illustrative embodiments not only avoid the overhead of taking a snapshot but also minimize the change of the dataflow in the pipeline.

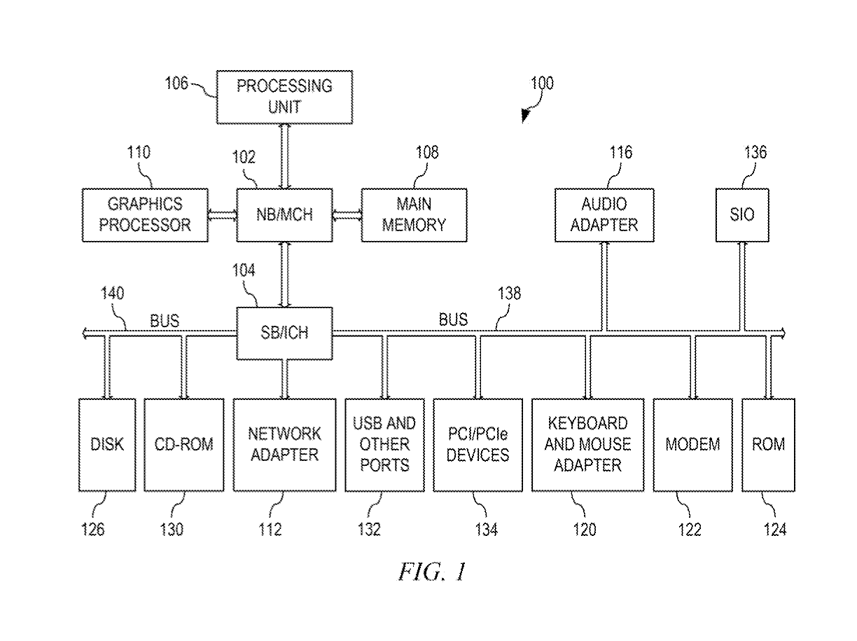

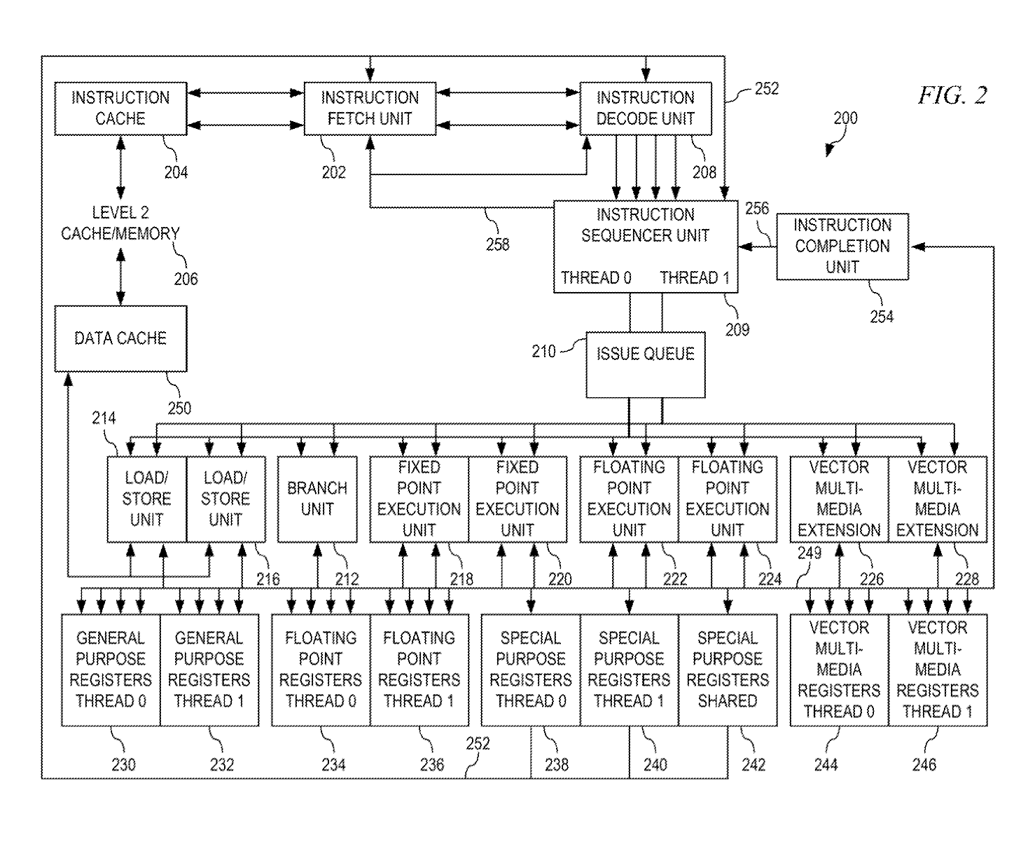

The illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. The example environments shown in FIGS. 1 and 2 are only examples and are not intended to state or imply any limitation with regard to the features of the present invention.

With reference now to FIG. 1, a block diagram of an example data processing system is shown in which aspects of the illustrative embodiments may be implemented. Data processing system 100 is an example of a computer, such as client computing device, server computing device, stand-alone computing device, or any other type or processor based computing device, in which mechanisms for implementing the functionality of the illustrative embodiments of the present invention may be provided. It should be appreciated that the term “processor” as it is used in the present description refers to any hardware implemented mechanism that is configured to execute instructions and/or operate on data to perform one or more computations to achieve a desired result.

In the depicted example, data processing system 100 employs a hub architecture including north bridge and memory controller hub (NB/MCH) 102 and south bridge and input/output (I/O) controller hub (SB/ICH) 104. Processing unit 106, main memory 108, and graphics processor 110 are connected to NB/MCH 102. Graphics processor 110 may be connected to NB/MCH 102 through an accelerated graphics port (AGP).

In the depicted example, local area network (LAN) adapter 112 connects to SB/ICH 104. Audio adapter 116, keyboard and mouse adapter 120, modem 122, read only memory (ROM) 124, hard disk drive (HDD) 126, CD-ROM drive 130, universal serial bus (USB) ports and other communication ports 132, and PCI/PCIe devices 134 connect to SB/ICH 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash basic input/output system (BIOS).

HDD 126 and CD-ROM drive 130 connect to SB/ICH 104 through bus 140. HDD 126 and CD-ROM drive 130 may use, for example, an integrated drive electronics (IDE) or serial advanced technology attachment (SATA) interface. Super I/O (SIO) device 136 may be connected to SB/ICH 104.

An operating system runs on processing unit 106. The operating system coordinates and provides control of various components within the data processing system 100 in FIG. 1. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 100 (Java is a trademark of Sun Microsystems, Inc. in the United States, other countries, or both).

As a server, data processing system 100 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 100 may be a symmetric multiprocessor (SMP) system including a plurality of processors in processing unit 106. Alternatively, a single processor system may be employed.

Instructions for the operating system, the object-oriented programming system, and applications or programs are located on storage devices, such as HDD 126, and may be loaded into main memory 108 for execution by processing unit 106. The processes for illustrative embodiments of the present invention may be performed by processing unit 106 using hardware logic provided therein which operates on computer usable program code, which may be located in a memory such as, for example, main memory 108, ROM 124, or in one or more peripheral devices 126 and 130, for example.

A bus system, such as bus 138 or bus 140 as shown in FIG. 1, may be comprised of one or more buses. Of course, the bus system may be implemented using any type of communication fabric or architecture that provides for a transfer of data between different components or devices attached to the fabric or architecture. A communication unit, such as modem 122 or network adapter 112 of FIG. 1, may include one or more devices used to transmit and receive data. A memory may be, for example, main memory 108, ROM 124, or a cache such as found in NB/MCH 102 in FIG. 1.

Referring now to FIG. 2, an exemplary block diagram of a conventional dual threaded processor design showing functional units and registers is depicted in accordance with one illustrative embodiment. Processor 200 may be implemented as processing unit 106 in FIG. 1 in these illustrative examples. Processor 200 comprises a single integrated circuit superscalar microprocessor with dual-thread simultaneous multi-threading (SMT) that may also be operated in a single threaded mode. Accordingly, as discussed further herein below, processor 200 includes various units, registers, buffers, memories, and other sections, all of which are formed by integrated circuitry. Also, in an illustrative embodiment, processor 200 operates according to reduced instruction set computer (RISC) techniques.

As shown in FIG. 2, instruction fetch unit (IFU) 202 connects to instruction cache 204. Instruction cache 204 holds instructions for multiple programs (threads) to be executed. Instruction cache 204 also has an interface to level 2 (L2) cache/memory 206. IFU 202 requests instructions from instruction cache 204 according to an instruction address, and passes instructions to instruction decode unit 208. In an illustrative embodiment, IFU 202 may request multiple instructions from instruction cache 204 for up to two threads at the same time. Instruction decode unit 208 decodes multiple instructions for up to two threads at the same time and passes decoded instructions to instruction sequencer unit (ISU) 209.

Processor 200 may also include issue queue 210, which receives decoded instructions from ISU 209. Instructions are stored in the issue queue 210 while awaiting dispatch to the appropriate execution units. In an illustrative embodiment, the execution units of the processor may include branch unit 212, load/store units (LSUA) 214 and (LSUB) 216, fixed point execution units (FXUA) 218 and (FXUB) 220, floating point execution units (FPUA) 222 and (FPUB) 224, and vector multimedia extension units (VMXA) 226 and (VMXB) 228. Execution units 212, 214, 216, 218, 220, 222, 224, 226, and 228 are fully shared across both threads, meaning that execution units 212, 214, 216, 218, 220, 222, 224, 226, and 228 may receive instructions from either or both threads. The processor includes multiple register sets 230, 232, 234, 236, 238, 240, 242, 244, and 246, which may also be referred to as architected register files (ARFs).

An ARF is a file where completed data is stored once an instruction has completed execution. ARFs 230, 232, 234, 236, 238, 240, 242, 244, and 246 may store data separately for each of the two threads and by the type of instruction, namely general purpose registers (GPRs) 230 and 232, floating point registers (FPRs) 234 and 236, special purpose registers (SPRs) 238 and 240, and vector registers (VRs) 244 and 246. Separately storing completed data by type and by thread assists in reducing processor contention while processing instructions.

The processor additionally includes a set of shared special purpose registers (SPR) 242 for holding program states, such as an instruction pointer, stack pointer, or processor status word, which may be used on instructions from either or both threads. Execution units 212, 214, 216, 218, 220, 222, 224, 226, and 228 are connected to ARFs 230, 232, 234, 236, 238, 240, 242, 244, and 246 through simplified internal bus structure 249.

In order to execute a floating point instruction, FPUA 222 and FPUB 224 retrieves register source operand information, which is input data required to execute an instruction, from FPRs 234 and 236, if the instruction data required to execute the instruction is complete or if the data has passed the point of flushing in the pipeline. Complete data is data that has been generated by an execution unit once an instruction has completed execution and is stored in an ARF, such as ARFs 230, 232, 234, 236, 238, 240, 242, 244, and 246. Incomplete data is data that has been generated during instruction execution where the instruction has not completed execution. FPUA 222 and FPUB 224 input their data according to which thread each executing instruction belongs to. For example, FPUA 222 inputs completed data to FPR 234 and FPUB 224 inputs completed data to FPR 236, because FPUA 222, FPUB 224, and FPRs 234 and 236 are thread specific.

During execution of an instruction, FPUA 222 and FPUB 224 output their destination register operand data, or instruction data generated during execution of the instruction, to FPRs 234 and 236 when the instruction has passed the point of flushing in the pipeline. During execution of an instruction, FXUA 218, FXUB 220, LSUA 214, and LSUB 216 output their destination register operand data, or instruction data generated during execution of the instruction, to GPRs 230 and 232 when the instruction has passed the point of flushing in the pipeline. During execution of a subset of instructions, FXUA 218, FXUB 220, and branch unit 212 output their destination register operand data to SPRs 238, 240, and 242 when the instruction has passed the point of flushing in the pipeline. Program states, such as an instruction pointer, stack pointer, or processor status word, stored in SPRs 238 and 240 indicate thread priority 252 to ISU 209. During execution of an instruction, VMXA 226 and VMXB 228 output their destination register operand data to VRs 244 and 246 when the instruction has passed the point of flushing in the pipeline.

Data cache 250 may also have associated with it a non-cacheable unit (not shown) which accepts data from the processor and writes it directly to level 2 cache/memory 206. In this way, the non-cacheable unit bypasses the coherency protocols required for storage to cache.

In response to the instructions input from instruction cache 204 and decoded by instruction decode unit 208, ISU 209 selectively dispatches the instructions to issue queue 210 and then onto execution units 212, 214, 216, 218, 220, 222, 224, 226, and 228 with regard to instruction type and thread. In turn, execution units 212, 214, 216, 218, 220, 222, 224, 226, and 228 execute one or more instructions of a particular class or type of instructions. For example, FXUA 218 and FXUB 220 execute fixed point mathematical operations on register source operands, such as addition, subtraction, ANDing, ORing and XORing. FPUA 222 and FPUB 224 execute floating point mathematical operations on register source operands, such as floating point multiplication and division. LSUA 214 and LSUB 216 execute load and store instructions, which move operand data between data cache 250 and ARFs 230, 232, 234, and 236. VMXA 226 and VMXB 228 execute single instruction operations that include multiple data. Branch unit 212 executes branch instructions which conditionally alter the flow of execution through a program by modifying the instruction address used by IFU 202 to request instructions from instruction cache 204.

Instruction completion unit 254 monitors internal bus structure 249 to determine when instructions executing in execution units 212, 214, 216, 218, 220, 222, 224, 226, and 228 are finished writing their operand results to ARFs 230, 232, 234, 236, 238, 240, 242, 244, and 246. Instructions executed by branch unit 212, FXUA 218, FXUB 220, LSUA 214, and LSUB 216 require the same number of cycles to execute, while instructions executed by FPUA 222, FPUB 224, VMXA 226, and VMXB 228 require a variable, and a larger number of cycles to execute. Therefore, instructions that are grouped together and start executing at the same time do not necessarily finish executing at the same time. “Completion” of an instruction means that the instruction is finishing executing in one of execution units 212, 214, 216, 218, 220, 222, 224, 226, or 228, has passed the point of flushing, and all older instructions have already been updated in the architected state, since instructions have to be completed in order. Hence, the instruction is now ready to complete and update the architected state, which means updating the final state of the data as the instruction has been completed. The architected state can only be updated in order, that is, instructions have to be completed in order and the completed data has to be updated as each instruction completes.

Instruction completion unit 254 monitors for the completion of instructions, and sends control information 256 to ISU 209 to notify ISU 209 that more groups of instructions can be dispatched to execution units 212, 214, 216, 218, 220, 222, 224, 226, and 228. ISU 209 sends dispatch signal 258, which serves as a throttle to bring more instructions down the pipeline to the dispatch unit, to IFU 202 and instruction decode unit 208 to indicate that it is ready to receive more decoded instructions. While processor 200 provides one detailed description of a single integrated circuit superscalar microprocessor with dual-thread simultaneous multi-threading (SMT) that may also be operated in a single threaded mode, the illustrative embodiments are not limited to such microprocessors. That is, the illustrative embodiments may be implemented in any type of processor using a pipeline technology and which provides facilities for speculative execution.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 100 in FIG. 1, which may implement a processor, such as the processor 200 in FIG. 2, modified to include the mechanisms of the illustrative embodiments, may take the form of any of a number of different data processing systems including client computing devices, server computing devices, a tablet computer, laptop computer, telephone or other communication device, a personal digital assistant (PDA), or the like. In some illustrative examples, data processing system 100 in FIG. 1 may be a portable computing device which is configured with flash memory to provide non-volatile memory for storing operating system files and/or user-generated data, for example. Essentially, data processing system 100 may be any known or later developed data processing system without architectural limitation.

As mentioned above, the illustrative embodiments provide mechanisms for performing checkpointing of registers during speculative modes of execution in out-of-order processors. The mechanisms of the illustrative embodiments use register renaming logic to achieve this checkpointing of registers. As is known in the art, register renaming is used to achieve greater levels of parallel execution by allowing logical registers to be renamed with tags pointing to different physical registers provided in the processor, where the values of the logical registers may be temporarily stored to achieve parallelism. A register renaming table data structure is stored in hardware of the processor that maps the logical registers to the physical registers. In this way, independent instructions are able to execute out-of-order. More information regarding register renaming may be found, for example, in Register Renaming, ECEN 6253 Advanced Digital Computer Design, Jan. 17, 2006, available at http://lgjohn.okstate.edu/6253/lectures/regren.pdf.

With the mechanisms of the illustrative embodiments, when a main thread of execution enters a speculative mode of execution, an additional renaming table data structure, referred to herein as the recovery renaming table, is reserved to hold non-speculative register renaming maps that will be used in the case of a roll-back operation. The recovery renaming table has as many entries as the number of architected registers in the architecture that are capable of being renamed by the processor. While these registers may be of different types (e.g., floating point, general purpose, condition registers, etc.), a single logical register namespace is assumed for the purposes of this description. This namespace may be mapped to registers of different types in a manner generally known in the art. Each entry in the recovery renaming table has a valid bit and a physical register number for the logical register associated with the entry. The physical register number in a recovery renaming table entry points to a physical register whose value corresponds to the logical register associated with the entry. The entries in the recovery renaming table are updated dynamically as renaming of registers occurs during a speculative mode of execution. Such updates are only performed on a first renaming operation during the speculative mode of execution such that the recovery renaming table stores the state of the register renaming table prior to entry into the speculative mode of execution for those registers that undergo a renaming during speculative execution.

As one example implementation, upon entering the speculative mode of execution, every entry in the recovery renaming table becomes invalid by resetting the valid bit. Entry into a speculative mode of execution may be detected when a specific group of instructions are decoded. For different kinds of speculative executions, a different instruction can be a triggering instruction. For example, a branch instruction itself is a triggering instruction for branch speculation execution. A lock instruction can be an instruction to trigger a speculative mode of execution for speculative lock elision.

When a logical register is renamed in the speculative mode of operation, the register renaming table is updated with a new physical register number. However, in addition, with the mechanisms of the illustrative embodiments, a lookup operation is performed in the recovery renaming table to determine if an entry in the recovery renaming table indexed by the logical register number is valid or not. If the entry is not valid, the entry is updated with the old physical register number of the register renaming table and the valid bit is set to indicate a valid state. If the indexed entry in the recovery renaming table is already valid, no change to the recovery renaming table entry occurs. In this way, the recovery renaming table stores the physical register number associated with the logical register before entry into the speculative mode of execution. Thus, this information may be used as a dynamically generated checkpoint for registers actually accessed by the speculative execution such that the state may be rolled-back based on this information in the recovery renaming table.

When an instruction commits in the speculative mode of execution, a lookup operation is performed in the recovery renaming table with the target register number of the instruction that committed. If the indexed entry holds a valid register tag that is the same as the old mapping of the target logical register, the physical register annotated by the old mapping cannot be freed. This is because register renaming is a process of creating a mapping between a logical register to a new physical register in which a target logical register of an instruction is renamed, a new mapping is created, and the previous mapping for the logical register in the rename table is replaced with the new mapping. The old mapping is kept and usually flows with the instruction in the pipeline until the instruction commits. If the instruction successfully commits, the old mapping is thrown away. If the instruction is flushed for some reason, the old mapping is used to restore the rename table as if the mapping did not occur. The logical register annotated by the old mapping holds the value of the logical register that was created before entering the speculative mode of execution and thus, the value will be useful for the case of roll-back if it is necessary. If the stored register tag in the indexed recovery renaming table entry is different from the old mapping of the current target logical register, the physical register annotated by the old mapping can be safety freed because the physical register is not going to be used by a roll-back process even if one is necessary.

When a speculative execution has to be aborted or ends unsuccessfully, a roll-back operation is performed such that the state of the registers is returned to a state prior to entry into the speculative execution mode. Every in-flight speculative instruction, which may be in a global completion table (GCT) of the processor architecture, is traversed and the physical registers annotated by the new mappings to the target logical register of the aborted instructions are freed. The old mappings of the target logical registers are compared with the values stored in the recovery renaming table. If the old mappings of the target logical registers and the physical register tag values stored in the recovery renaming table are different, the physical registers annotated by the old mapping are freed as well. Meanwhile, all valid entries in the recovery renaming table are written into the register rename table.

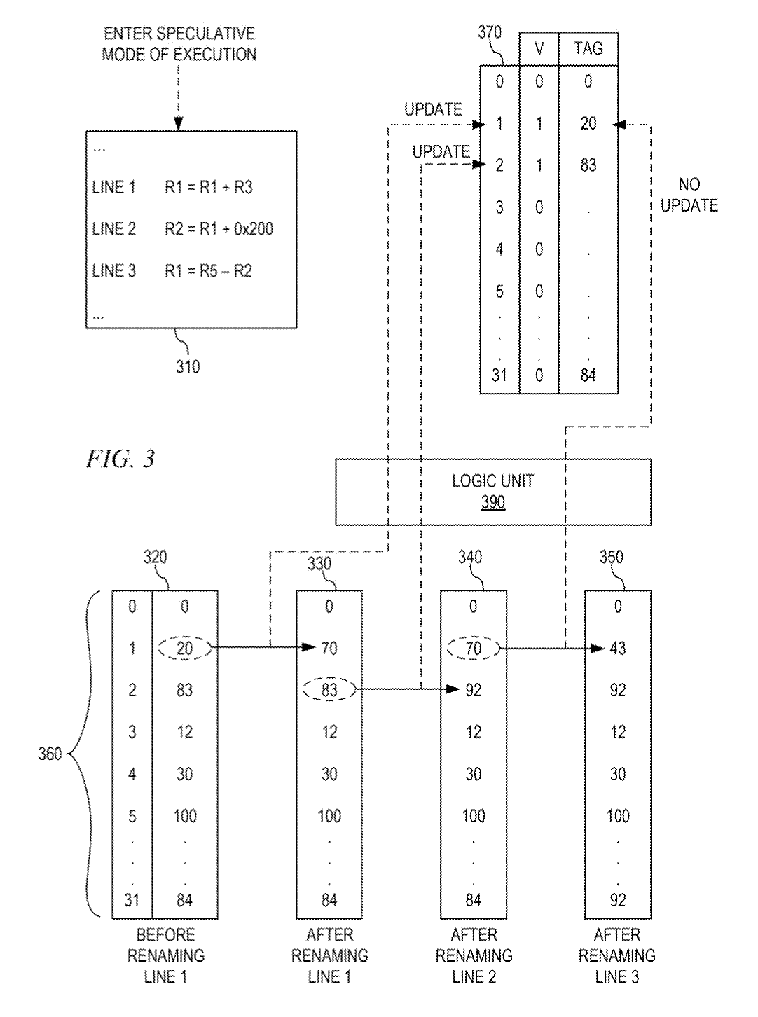

FIG. 3 is an example diagram illustrating an operation for using a register renaming table and recovery renaming table in accordance with one illustrative embodiment. As shown in FIG. 3, a portion of code 310 comprises three lines in which logical register R1 is referenced. Line 2 is dependent upon line 1 since the value of the logical register R2 is based on the value of R1. Line 3 in the portion of code 310 is dependent upon line 2 since the value of R1 is dependent upon the value of R2. Moreover, line 3 updates the value of the logical register R1.

Elements 320-350 illustrate the state of the register renaming table at various stages of speculative execution of the portion of code 310. Element 320 illustrates the state of the register renaming table 360 just prior to renaming of the target logical register of line 1. This state corresponds to the state prior to entry into the speculative execution. Element 330 corresponds to the state of the register renaming table 360 after the register renaming performed as part of the speculative execution of line 1 in the portion of code 310. Element 340 corresponds to the state of the register renaming table 360 after the register renaming performed as part of the speculative execution of line 2. Element 350 corresponds to the state of the register renaming table 360 after the register renaming performed as part of the speculative execution of line 3.

It should be appreciated that the register renaming table 360 may be a data structure stored in a memory of the processor, such as a RAM, SRAM, or the like. The register renaming table 360 may be stored in the register file of the processor, for example, or may be a separate structure from the register file. As shown in FIG. 3, the register renaming table 360 has an entry for each logical register, e.g., registers R0-R31 which correspond to indices 0-31 of the register renaming table 360. Each entry includes a physical register number identifying the logical register to which the logical register has been most recently mapped during the speculative execution. While the instruction set architecture of the processor requires that the instructions in the code reference the logical registers, these logical registers may be renamed or mapped to the additional physical registers so that parallel execution may be implemented.

While only 32 indices and logical registers are illustrated in this example, this is intended to only be an example and not a limitation. Other processor architectures may utilize more or less logical registers than that depicted in FIG. 3. Implementation of the present invention in these other architectures is intended to be covered by the present description and accompanying claims.

It should also be appreciated that the physical register number contained in the recovery renaming table may not be limited to an index in a single monolithic physical register file. To the contrary, the physical register number may be a reference to a physical register that is contained within a register file of a different organization, for example hierarchical or distributed.

As shown in FIG. 3, in addition to the register renaming table 360, the illustrative embodiments further provide a recovery renaming table 370 which is dynamically updated in response to updates to the register renaming table 360 during speculative execution. The recovery renaming table 370 does not store a snap shot of the register renaming table 360. Instead, only the maps that are created prior to the current speculative execution and are subjected to be replaced by new mappings during the speculative execution are actually stored in the recovery renaming table 370. In this way, the recovery renaming table 370 stores a checkpoint of the logical registers just prior to entry into speculative execution for those registers that are updated during the speculative execution. This checkpoint can be used to restore the state of the logical registers should a roll-back of the speculative execution becomes necessary.

Referring again to FIG. 3, as can be seen, just prior to speculative execution of line 1 in the portion of code 310, the register renaming table 360 has the state shown in element 320. As a result of the speculative execution of line 1 in the portion of code 310, the logical register R1 is renamed such that the resulting value from the execution of line 1 is stored in the physical register R70, shown in element 330. As a result of the renaming performed by the transition from element 320 to element 330, a corresponding entry for the logical register R1 is updated, by logic unit 390, in the recovery renaming table 370 to store the previous rename map of the logical register R1, which was the physical register R20. That is, entry 1 in recovery renaming table 370 is updated to store the physical register number “20” which had been previously stored in the register rename table 360. In addition, the valid bit (v) for the entry is updated by the logic unit 390 to indicate that the entry stores a valid map for purposes of roll-back or recovery should it become necessary. The valid bit is not essential, but is used to provide a simpler comparison operation since it is simpler to compare a single valid bit than performing a compare on multiple bits of a rename tag. It should be appreciated that such a compare of the multiple bits of a rename tag can be used instead without departing from the spirit and scope of the illustrative embodiments.

As shown in FIG. 3, after register renaming due to the speculative execution of line 1, the register renaming table 360 has the state shown in element 330. Then, line 2 of the portion of code 310 is speculatively executed causing an update of the value in logical register R2. As a result, the map stored in entry 2 of the register renaming table 360 is updated to point to physical register 92 which stores the result of the execution of line 2. In response to the register renaming occurring in the register renaming table 360, the recovery renaming table 370 is updated by the logic unit 390 to store the previous map for physical register R2 since this is the first update to the map of the logical register R2 following entry into the speculative mode of execution. Thus, the corresponding entry 2 in the recovery renaming table 370 is updated by the logic unit 390 to store the physical register number 83 which was previously stored in the register renaming table 360 for logical register R2. Again, the valid bit (v) for entry 2 is set by the logic unit 390 to indicate that the entry 2 includes a valid map for roll-back or recovery.

After register renaming due to the speculative execution of line 2, the register renaming table 360 has the state shown in element 340. Thereafter, line 3 of the portion of code 310 is speculatively executed with the result of this speculative execution being stored again in logical register R1. This causes another renaming of logical register R1 such that the register renaming table 360 is again updated to map the logical register R1 to physical register 43 as shown in element 350. Again, in response to the register renaming performed due to the speculative execution of line 3, an attempt is made by the logic unit 390 to update the recovery renaming table 370. However, this time the update to the recovery renaming table 370 fails. That is, because there is already a valid map for logical register R1 in the recovery renaming table 370 due to the register renaming that occurred in response to the speculative execution of line 1 (see elements 320-330), the subsequent register renaming does not result in an update to the entry in the recovery renaming table 370. This is because the recovery renaming table 370 is intended to store only the register mappings for logical registers just prior to entry into the speculative mode of execution. Thus, only the first register renaming associated with a logical register causes an update to occur in the recovery renaming table 370 such that the recovery renaming table 370 stores the register mappings just prior to the first register renaming that occurs for that logical register after entry into the speculative mode of execution. In this way, the recovery renaming table 370 stores a dynamically built-up checkpoint of these register mappings.

In the event that a roll-back or recovery from speculative execution becomes necessary, the valid entries in the recovery renaming table 370 may be used by the logic unit 390, or other logic provided in the processor, to write back the mappings in these entries to the register renaming table 360. Thus, for example, the entries 1 and 2 in recovery renaming table 370 may be written back to the corresponding entries in the register renaming table 360. Therefore, the original mappings or logical register R1 to physical register 20 and logical register R2 to physical register 83 may be restored in the register renaming table 360. Should roll-back or recovery not be necessary, the entries in the recovery renaming table 370 may be reset to an invalid state at the end of the current speculative mode of execution or at the beginning of the next speculative mode of execution, thereby discarding the information stored in the recovery renaming table 370.

Because registers are allocated from a pool of physical registers, once a register is allocated, and renaming is performed to point to this allocated register, the register cannot be re-allocated to another value without first being released back to the pool. Thus, the mappings in the recovery renaming table 370 are valid throughout the speculative execution. Thus, recovery to the state represented in the recovery renaming table 370 does not result in any stale values or incorrect values being utilized but rather a recovery to the last known valid state of the register renaming and hence, last known valid values.

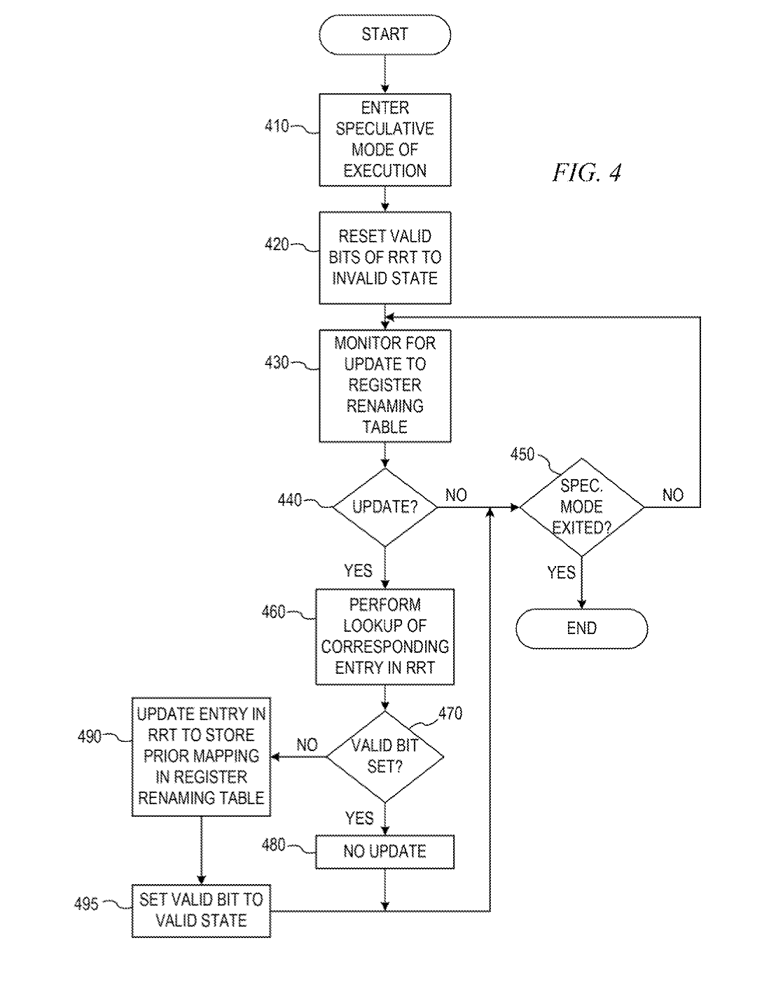

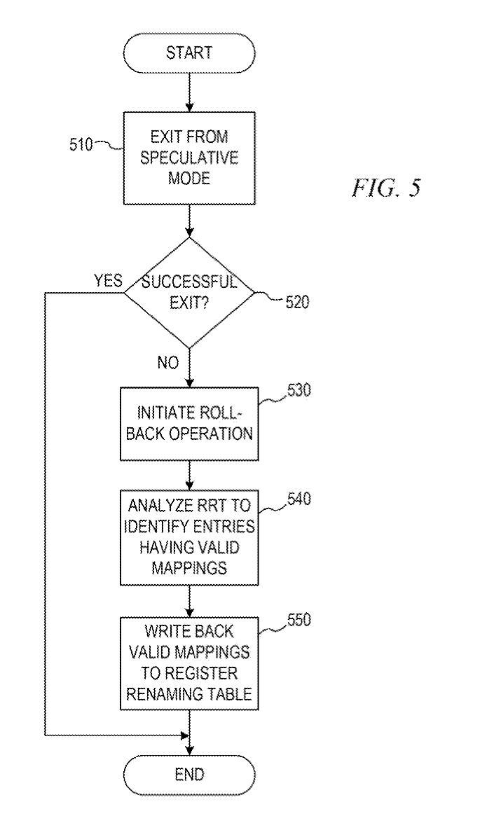

FIGS. 4-5 provide example flowcharts of the various operations that may be performed by the mechanisms of the illustrative embodiments. These operations may be performed by logic built into the processor architecture, such as logic unit 390 in FIG. 3, or the like.

FIG. 4 is a flowchart outlining an example operation for updating a recovery rename table in accordance with one illustrative embodiment. As shown in FIG. 4, the operation starts by the execution of a portion of code entering into a speculative mode of execution (step 410). The valid bits of the recovery renaming table are reset to an invalid state (step 420) and logic monitors for an update to the register renaming table (step 430). A determination is made as to whether an update to the register renaming table is performed or not (step 440). If an update to the register renaming table is not performed, a determination is made as to whether the speculative mode of execution has exited or not (step 450). If the speculative mode of execution has exited, the operation terminates; otherwise the operation returns to step 430.

If an update to the register renaming table has been performed (step 440), a lookup of an entry in the recovery renaming table corresponding to the logical register is performed (step 460) and a determination is made as to whether a valid bit for the corresponding entry in the recovery renaming table is set to a valid state or not (step 470). If the valid bit is set to a valid state, then an update of the entry is not performed (step 480) and the operation continues to step 450. If the valid bit is not set to a valid state, then an update of the entry is performed to store the mapping to a physical register corresponding to the mapping in the register rename table prior to the update to the register rename table (step 490). The valid bit for the entry is then set to a valid state (step 495) and the operation continues to step 450.

FIG. 5 is a flowchart of an example operation for handling an end of a speculative mode of execution using a recovery renaming table in accordance with one illustrative embodiment. As shown in FIG. 5, the operation starts with an exit from a speculative mode of execution (step 510). For example, the operation starting at step 510 may be entered from step 450 in FIG. 4 when a determination is made that the speculative mode of execution has been exited.

A determination is made as to whether the speculative mode of execution has exited successfully or not (step 520). If the speculative mode of execution has exited successfully, then no other operation on the recovery renaming table is necessary and the operation terminates. If the speculative mode of execution has not exited successfully, i.e. there is an abort of the speculative execution, then a roll-back operation is initiated (step 530). As part of the roll-back operation, the recovery renaming table is analyzed to identify those entries having valid mappings based on the valid bits being set in the recovery renaming table (step 540). The mappings for the valid entries are written back to the register renaming table (step 550). The operation then terminates. It should be appreciated that the write-back of the valid entries from the recovery renaming table to the register renaming table may be done at substantially a same time as other recovery actions, in the other parts of the pipeline, that occur due to the current speculation failure, are being performed.

Thus, the illustrative embodiments provide mechanisms for performing checkpointing of registers during speculative modes of execution in out-of-order processors. The mechanisms of the illustrative embodiments build-up the checkpoint as instructions are executed in a speculative mode of execution based on the register rename mappings in the register renaming table at the time just prior to entering the speculative mode of execution. As a result, the checkpoint stores only those mappings that are updated during the speculative mode of execution. The illustrative embodiments avoid the large overhead of performing snap-shots of the state of the register file or the register renaming table. Thus, a more efficient operation of the processor is achieved.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for generating a checkpoint for a speculatively executed portion of code, comprising:
identifying, by a processor of the data processing system, during a speculative execution of a portion of code, a register renaming operation occurring to an entry in a register renaming table of the processor;
in response to the register renaming operation occurring to the register renaming table, determining, by the processor, if an update to an entry in a hardware-implemented recovery renaming table of the processor is to be performed; and
updating, by the processor, the entry in the hardware-implemented recovery renaming table in response to a determination that the entry in the recovery renaming table is to be updated, wherein the entry in the recovery renaming table is part of the checkpoint for the speculative execution of the portion of code.

2. The method of claim 1, further comprising:
reserving the recovery renaming table, at a time of entry into a speculative mode of execution of the processor, to hold non-speculative register renaming map information for use in the case of a roll-back operation, wherein the recovery renaming table has a same number of entries as a number of architected registers of the processor.

3. The method of claim 1, wherein each entry in the recovery renaming table has a valid bit and a physical register number for a logical register associated with the entry, wherein the physical register number points to a physical register whose stored value corresponds to a stored value of the logical register associated with the entry.

4. The method of claim 3, further comprising:
resetting the valid bits of each of the entries in the recovery renaming table in response to entry into a speculative mode of execution of the portion of code; and
in response to updating the entry in the recovery renaming table, setting a valid bit associated with the entry in the recovery renaming table to indicate that the entry in the recovery renaming table is valid.

5. The method of claim 1, wherein determining if an update to an entry in a hardware-implemented recovery renaming table of the processor is to be performed comprises:
performing a lookup operation in the recovery renaming table based on a logical register identifier;
determining if an entry in the recovery renaming table corresponding to the logical register identifier is valid; and
performing the update of the entry in the recovery renaming table to the entry corresponding to the logical register identifier in response to a determination that the entry in the recovery renaming table corresponding to the logical register identifier is not valid.

6. The method of claim 5, wherein on update of the entry in the recovery renaming table corresponding to the logical register identifier is not performed in response to a determination that the entry in the recovery renaming table corresponding to the logical register identifier is valid.

7. The method of claim 1, wherein the recovery renaming table stores register renaming information, indicating a register mapping that existed just prior to a register renaming operation, for only each first register renaming operation applied to logical registers that occurs after entry into speculative execution of the portion of code, and wherein subsequent register renaming operations applied to the logical registers after entry into speculative execution of the portion of code do not result in an update of the register renaming information in the recovery renaming table.

8. The method of claim 1, further comprising:
detecting, by the processor, an abort of the speculative execution of the portion of code; and
in response to the abort of the speculative execution of the portion of code, performing, by the processor, a roll-back operation based on information stored in the hardware-implemented recovery renaming table to restore a state of register mapping to a state existing just prior to entry into the speculative execution of the portion of code.

9. The method of claim 8, wherein performing the roll-back operation comprises:
analyzing, by the processor, entries of the recovery renaming table to identify entries in the recovery renaming table indicated as being valid entries; and
writing back, by the processor, register renaming information stored in valid entries of the recovery renaming table to the register renaming table.

10. The method of claim 1, wherein entries in the recovery renaming table are indexed by logical register number, and wherein each entry in the recovery renaming table corresponds to a different logical register and stores a map of a corresponding logical register to a physical register of the processor.

11. An apparatus, comprising:
a register renaming table unit;
a recovery renaming table unit; and
a logic unit coupled to both the register renaming table unit and the register recovery table unit, wherein the logic unit operates to:
identify, during a speculative execution of a portion of code, a register renaming operation occurring to an entry in the register renaming table;
in response to the register renaming operation occurring to the register renaming table, determine if an update to an entry in the recovery renaming table unit is to be performed; and
update the entry in the recovery renaming table unit in response to a determination that the entry in the recovery renaming table unit is to be updated, wherein the entry in the recovery renaming table unit is part of a checkpoint for the speculative execution of the portion of code.

12. The apparatus of claim 11, wherein the apparatus further comprises a processor, and wherein the logic unit further operates to:
reserve the recovery renaming table unit, at a time of entry into a speculative mode of execution of the processor, to hold non-speculative register renaming map information for use in the case of a roll-back operation, wherein the recovery renaming table unit has a same number of entries as a number of architected registers of the processor.

13. The apparatus of claim 11, wherein each entry in the recovery renaming table unit has a valid bit and a physical register number for a logical register associated with the entry, wherein the physical register number points to a physical register whose stored value corresponds to a stored value of the logical register associated with the entry.

14. The apparatus of claim 13, wherein the logic unit further operates to:
reset the valid bits of each of the entries in the recovery renaming table unit in response to entry into a speculative mode of execution of the portion of code; and
in response to updating the entry in the recovery renaming table unit, set a valid bit associated with the entry in the recovery renaming table unit to indicate that the entry in the recovery renaming table unit is valid.

15. The apparatus of claim 11, wherein the logic unit determines if an update to an entry in the recovery renaming table unit is to be performed comprises:
performing a lookup operation in the recovery renaming table unit based on a logical register identifier;
determining if an entry in the recovery renaming table unit corresponding to the logical register identifier is valid; and
performing the update of the entry in the recovery renaming table unit to the entry corresponding to the logical register identifier in response to a determination that the entry in the recovery renaming table unit corresponding to the logical register identifier is not valid.

16. The apparatus of claim 15, wherein an update of the entry in the recovery renaming table unit corresponding to the logical register identifier is not performed in response to a determination that the entry in the recovery renaming table unit corresponding to the logical register identifier is valid.

17. The apparatus of claim 11, wherein the recovery renaming table unit stores register renaming information, indicating a register mapping that existed just prior to a register renaming operation, for only each first register renaming operation applied to logical registers that occurs after entry into speculative execution of the portion of code, and wherein subsequent register renaming operations applied to the logical registers after entry into speculative execution of the portion of code do not result in an update of the register renaming information in the recovery renaming table unit.

18. The apparatus of claim 11, wherein the logic unit further operates to:
detect an abort of the speculative execution of the portion of code; and
in response to the abort of the speculative execution of the portion of code, perform a roll-back operation based on information stored in the recovery renaming table unit to restore a state of register mapping to a state existing just prior to entry into the speculative execution of the portion of code.

19. The apparatus of claim 18, wherein the logic unit performs the roll-back operation by:
analyzing entries of the recovery renaming table unit to identify entries in the recovery renaming table unit indicated as being valid entries; and
writing back register renaming information stored in valid entries of the recovery renaming table unit to the register renaming table.

20. The apparatus of claim 11, wherein:
the apparatus further comprises a processor,
entries in the recovery renaming table unit are indexed by logical register number, and
each entry in the recovery renaming table unit corresponds to a different logical register and stores a map of a corresponding logical register to a physical register of the processor.
